(19) United States
(12) Patent Application Publication
(10) Pub. No.: US 2017/0219471 A1
(43) Pub. Date: Aug. 3, 2017

(54) Evaluating Railway Ties

(71) Applicant: Vector Corrosion Services, Inc., Tampa, FL (US)

(72) Inventors: Paul Fisk, Sterling, MA (US); Eric de Rivera, West Boylston, MA (US); Benson Armitage, Whitinsville, MA (US)

(21) Appl. No.: 15/408,995

(22) Filed: Jan. 18, 2017

Related U.S. Application Data
(60) Provisional application No. 62/280,799, filed on Jan. 20, 2016.

(51) Int. Cl. G01N 3/30; G01N 17/00

(52) U.S. Cl. CPC G01N 3/30; G01N 17/006

(57) ABSTRACT

A method of evaluating railway ties for deterioration is mounted on a moving vehicle along the rails where the presence of the tie is detected and an impact energy source is used to create at least one wave in a surface of the tie which travels longitudinally along the tie. At positions spaced longitudinally from the source, the time of arrival of the wave is detected typically by a series of sensors responsive to air pressure changes to determine a speed of propagation of the wave in the tie and, in the event that the speed in said tie is below a predetermined speed, an output indication is provided regarding the deterioration of the tie, which can include a real time marking of the tie detected.

This application claims the benefit under 35 USC 119 (e) of Provisional Application 62/280,799 filed Jan. 20, 2016, the disclosure of which is incorporated herein by reference.

This invention relates to a method of evaluating railway ties for deterioration. The method can be carried out by passing the system over a plurality of ties carrying rails so as to generate data on each of the ties. This method can be used to determine the need to replace specific individual highly deteriorated ties or can be used to develop a maintenance program for replacing all ties in a particular area. In this way the safety of a rail system can be better maintained with potential for lower cost of replacement of the ties.

### BACKGROUND OF THE INVENTION

Wood ties are widely used in rail systems. Concrete ties are a key element in high speed rail. Concrete and wooden ties deteriorate in service. A reliable scientific assessment of the structural performance of each tie is essential to ensure the safe railway operation. Data indicating specific locations of deteriorated/weakened wooden and concrete ties is important to safe rail operation. Data collected by performing analysis of railway ties at different points in time can be used to determine the anticipated deterioration rate and provide data to plan repairs or replacement. Repair planning can include identifying weak ties for replacement before adjacent “Good” ties deteriorate or determine when a stretch of ties should be scheduled for replacement. It is well documented that deteriorating concrete and wooden ties are an issue for railroads. Therefore there is a need for an evaluation or testing method to identify internal flaws within the ties, scientifically document the structural integrity and assist in scheduling repairs or replacement.

Dissection and crack mapping observations from decommissioned concrete ties indicate the pattern of crack propagation does not include cracking visible in the top surface until the side and cross-section cracks have progressed to a moderate stage of deterioration. Top cracks appear later-in-time and unfortunately are not an early indicator of deterioration. Ties which have been removed from service demonstrate that by the time a crack is visible in the top surface to a length of several inches, the pattern of cracking along the sides of the crosstie and within the crosstie has progressed significantly. Visual inspection of the exposed surfaces of ties is less capable of identifying ties in the early stages of cracking and deterioration compared to the non-destructive testing using an impact energy source.

### SUMMARY OF THE INVENTION

According a first aspect of the invention there is provided a method of testing railroad ties comprising:

providing an impact energy source that impacts the tie so as to create waves that propagate through the tie;

providing one or more sensing devices arranged to sit above the surface of the tie so as to avoid contact therewith, where the sensing devices detect movement of the surface caused by the waves propagating therein; and

analyzing and/or recording the detected pressure waves to determine properties of the tie.

According to a further definition of the invention there is provided a method of testing railroad ties comprising:

providing an impact energy source that impacts the concrete tie so as to create Rayleigh and compressional waves that propagate through the tie;

providing one or more sensing devices arranged to sit above the surface of the tie, where the sensing devices detect pressure waves that emanate from the tie due to the Rayleigh and compressional waves; and analyzing and/or recording the detected pressure waves to determine properties of the concrete structure.

The ties tested can be concrete or wood as the methods described herein can be effective for both.

In one suitable arrangement, the analysis system determines particularly the speed of the Rayleigh waves that propagate through the concrete. The uniformity of the speed can also be detected and assessed. However the method can operate simply by detecting the passage of the waves along the surface of the tie so as to determine a specific time when the passage occurs, for example at a leading edge. That is the speed and optionally the uniformity of the Rayleigh waves that propagate through the concrete are inversely related to the degree of deterioration or cracking of the concrete.

The system as described herein is arranged to detect movement of the surface of the tie typically in a direction and right angles to the surface where the movement generates changes in air pressure causing soundwaves to be emitted from the surface. These surface movements of the tie are complex and typically are known as or include Rayleigh waves. However such waves have components which are transmitted through the thickness of the tie both in the vertical and horizontal directions. These waves can reflect from surfaces and return to the upper surface of the tie where the movements are detected by the sensing system. The velocity of the surface or Rayleigh waves is determined or modified both by cracks or other imperfections at the surface and by such cracks or imperfections through the thickness of the tie both vertically and horizontally. This is caused by the fact that each particle at the surface can only move when it is permitted by adjacent particles in all directions so that the imperfections in those directions also affect the velocity at the surface.

According to a further definition of the invention there is provided a method of evaluating railway ties for deterioration comprising;

moving a vehicle along rails mounted on the railway ties;

detecting presence of one of the ties under the vehicle;

providing on the vehicle an impact energy source which is activated on detection of said one of the ties to create at least one wave in a surface of the tie which travels longitudinally of the tie;

at positions spaced longitudinally from the impact energy source providing a plurality of sensing devices to detect said at least one wave;

detecting a time of arrival of said at least one wave and analyzing the time of arrival from said sensing devices to determine a speed of said at least one wave in the tie;

and, in the event that the speed in said tie is below a predetermined speed, providing an output indication of a deterioration of the tie.

In the preferred arrangement the impact energy source comprises a body carried on a support which provides an impact on the surface of the tie and is immediately retracted so as to prevent sliding movement across the surface. In this way the source of energy is effectively instantaneous and there is no scraping of the body across the surface which can generate soundwaves (noise) which interferes with the analysis of the surface waves in the tie. It is important therefore to prevent extraneous sounds as much as possible so that the sensors also have no component contacting the surface of the tie which can generate extraneous noise in the surface waves. Yet further, additional steps can be taken to reduce extraneous vibrations/noise so as to avoid interfering with the sensor detection. For example the vehicle is preferably carried on wheels which are of a polymer, rubber or plastics material which is resilient or flexible to provide a quiet rolling action. Such wheels are also non-conductive and hence prevent grounding across the two rails which is unacceptable in railway management practice.

In order to provide a long-distance communication of the waves through the tie, preferably the impact energy source is shaped, arranged and actuated to provide a frequency of waves in the tie which includes frequencies below 25 kHz and preferably below 10 kHz and more preferably below 5 kHz. It has been found that such low frequency waves provide a better communication of the wave through the tie allowing it to reach further toward the opposite end of the tie. The impact energy source generates a range of frequencies in a broad spectral signal in the range of 2 kHz to 60 kHz, including the above lower frequency components together with the higher frequency components typically up to 60 kHz.

Also, in order to provide the required distance of travel of the surface wave, the impact energy source is preferably shaped, arranged and actuated to provide a total energy at impact which is greater than 3 joules and more preferably greater than 4 joules and up to 60 joules.

Preferably the analysis includes detecting the speed of the waves at different locations across the tie and comparing the different speeds to determine a uniformity of the speed. That is, the system typically includes at least three sensors at spaced positions along the tie so that different velocities can be detected between the first and second, first and third and second and third sensors. In one part of the analysis, these velocities can be compared both to determine an average and to determine any significant variations which may be indicative of a fault in the system or of ties with the unusual characteristics.

Preferably as another part which can generate further important information, the analysis includes detecting the waves at different locations across the tie and generating for each impact a waveform over a period of time of the impact at the location and comparing the waveforms from different locations and/or from different ties. That is, each impact generates a waveform over a period of time including a leading edge and also further downstream components. In the main analysis, the leading edge is detected so as to use this location in the waveform to calculate velocity as the leading edge reaches the separate sensors.

However preferably the period of time includes times in advance of the impact obtained by recording a continual waveform and obtaining from the continual waveform recorded a window of time in advance of and after the impact. That is, the sensors are generating a continual waveform which is continually stored in a buffer arrangement. At the time of detecting the leading edge of a waveform of an impact, this detection is used to trigger the extraction from the waveform of a window in the waveform which includes components prior to the triggering impact leading edge and subsequent to that leading edge so as to extract a waveform characteristic which is created by the impact. This waveform in the extracted window can then be compared to other such waveforms for example in a waterfall plot. This information can be provided to an operator of the system and this will provide an early indication of faults in the operating process since the waveform may become distorted. The comparison of the waveforms can also provide information relating to the characteristics of the tie.

As set forth above, the impact and the sensors detect waves at the surface which are changed by wave components that are reflected between surfaces of the structure and are indicative of delamination of or cracks in the structure below the surface.

In the preferred method of analysis, the impact energy source that impacts the tie creates Rayleigh surface waves that propagate through the tie. These waves that move along the surface and also provide pressure changes in the air adjacent to the surface which can be detected by microphones.

In the preferred arrangement, the sensing devices are arranged to sit at a position above the surface of the tie so as to detect pressure waves in the air that emanate from the tie due to the Rayleigh surface waves therein.

In the preferred arrangement, the analysis system determines the speed and optionally the uniformity of the Rayleigh waves that propagate through the concrete.

In a preferred arrangement the impact energy source is provided by a ball operated by a rotational solenoid so as to engage a surface of the tie. However other tethered or dree projectiles may be used provided they are removed from the surface after impact.

However the intention is to provide a single impact type source of energy on the surface of the tie. In this way the wave generated by the impact energy is typically a Rayleigh wave at the surface of the tie with a specific leading edge which can be detected to determine a time of arrival of the wave. This type of impact also generates specifically Rayleigh waves which are of sufficient amplitude to cause movement and pressure changes in the air at the surface so that these pressure changes in the air can be detected at a position remote from the surface of the tie, for example by microphone type systems.

In a preferred arrangement the presence of one of the ties under the vehicle is detected by a proximity sensor, a magnetic sensor, a contact sensor, or a video sensor.

The specific detection of the presence of the tie allows the system to move continually over the ties along the rails so that each tie is detected in turn and is analysed by the system as its presence is detected. This arrangement therefore avoids the problems which arise when the ties are not accurately located.

Preferably the non-contact sensors each comprise a microphone positioned inside a tube, the open end of which is directed toward the surface of the tie.

The mounting of the microphone inside the tube thus provides a directional control of the soundwaves detected so that the sounds from the surface are preferentially collected. In addition it is desirable to use a microphone which is of the type which is noise cancelling. Such systems can use a software arrangement which continually detects the sounds arriving at the microphone and uses an analysis of the continual sound to generate information relating to the sound caused by extraneous noise, which is generally relatively constant, and to subtract that constant noise signal from the actual signals to be detected. Arrangements of this type are commercially available.

In some cases the non-contact sensor is laser system which directly detects movement of surface. Such laser systems direct a laser beam at the surface and can detect movement of the surface from the reflected beam.

In order to provide a suitable usable output for the rail management system, the output indication of a deterioration of the tie can be used to place the ties in categories of deterioration similar to the conventional categories obtained by visual analysis.

In order to calculate the categories to be applied, velocity ranges for deteriorated ties are determined and then used to classify the tie tested in the categories of deterioration.

In a preferred arrangement, the analysis is performed in real time and the system includes a marking system for marking the tie under test in the event that it is determined to be deteriorated so that the marking can be carried out as the device passes over the tie under analysis. The marketing can be carried out by any suitable marking system such as an injection of paint actuated by the controlling processor.

In a preferred arrangement there is provided a position recording function to record position of each defective tie to provide a report to the Railway Company of the location of the defective ties. For example the data can be analyzed in a post-survey analysis of the data to produce a summary report of the number and location of defective ties and data from a subsequent survey is compared to previously recorded data for each tie to determine deterioration vs time and rate of deterioration of ties.

Preferably the processor establishes a zero time when the wave first passes a first sensor closest to impact energy sources, and the time for the signal to propagate to a second and third sensor is used to calculate the average wave velocity.

Preferably the system includes a vehicle with wheels for rolling on the rails where the wheels are formed of a polymer, rubber or resilient plastics material so as to reduce noise which can interfere with the sensor analysis.

In a particularly preferred arrangement for management of rail tie deterioration, the analysis is repeated after a period of time and results from the separate analyses compared to determine a rate of deterioration. That is the management system can include traversing the vehicle over a rail system with the results of the analysis recorded in a suitable storage system. Periodically the process is repeated to generate further information concerning the status on the level of deterioration of individual ties. This repeated analysis of the ties along a length of track can provide valuable information concerning the level of deterioration and the potential for further deterioration to allow the system to be used in a program for tie replacement. In this way the status of the ties can be properly monitored to allow them to be maintained in use for as long a time as possible while maintaining the required safety level. As part of this process, it is of course necessary to maintain a record of the ties which have been analysed and this can preferably be done by generating location information which indicates which particular tie along the length of rail track has been analysed. This information can be generated by identifying particular ties or more preferably by simple distance information from a known starting point.

Also as part of the system, preferably there is provided a camera for generating a visual image of the tie under test which is recorded with data from the analyses. In this way the data obtained by the system can be later analysed repeatedly also in combination with visual inspection of the particular ties as obtained by the camera image.

In order to obtain the most data relating to a particular tie, preferably the system uses two duplicate detection systems each including an impact energy source, a sensor array and a proximity sensor for detecting the presence of the tie and actuating the impact energy source. That is there is preferably provided a first impact energy source at one end of the tie and a first array of sensors along the tie for a first analysis and a second impact energy source at a second end of the tie and a second array of sensors along the tie for carrying out a second analysis for comparison with the first set of data from the first end.

Preferably the first array comprises a first sensor between the first impact source at the first end of the tie and a first rail, a second sensor on the other side of the first rail and a third sensor adjacent the second rail. Preferably the second array comprises a first sensor between the second impact source at the second end of the tie and the second rail, a second sensor on the other side of the second rail and a third sensor adjacent the first rail. This arrangement is preferred since analysis and data obtained indicates that the data is most effective over a length which is less than the full length of the tie. Therefore the first detection system provides an analysis of the tie from the impact energy source at the end of the tie to a position adjacent the second rail and spaced from the second end of the tie. The second detection system operates in the reverse direction from the second end of the tie. The summation of the data obtained by these two detection systems provides an analysis of the velocity of the waves along the full length of the tie and therefore the level of deterioration of the tie along its full length.

The method disclosed in more detail hereinafter provides a concrete testing system. The system has an impact energy source that impacts a concrete structure so as to create compressional, shear and surface Rayleigh waves that propagate through the structure. There are one or more sensing devices arranged to be located above the surface of the concrete structure. The sensing devices detect the Rayleigh and compressional waves that emanate from the structure. The detected pressure waves can be analyzed to determine properties of the concrete. For example, the speed that the Rayleigh wave propagates through the concrete is proportional to the degree of deterioration or cracking of the concrete. Also, an echo signal (i.e., compressional waves reflected between surfaces of the structure) can be used to detect delamination of the structure.

Ties with uneven surfaces and ties which are cantered (inclined/tilted) due to tamping and unevenly spaced ties, as a result of non-uniform tie installation and tie replacement, are the primary hindrance to faster testing rates. The automated rail tie testing machine and method disclosed herein can dramatically improve production and testing rates. It accommodates non-uniform rail tie surfaces. The use of magnetic proximity switches activated by the presence of steel rail clips or steel rail plates and spikes is innovative and allows the machine to sense the location of a rail tie and to take a measurement while in motion. The use of non-contacting microphone sensors allows the machine to take measurements without having sensors in contact with the surface of the rail tie. The machine includes real time data analysis such that each rail tie can be rated using the 1 to 5 rail tie rating/ranking system, similar to that currently used by railroad visual tie inspections, where 1 is “good”/like new crosstie and 5 is a highly distressed tie.

As described in more detail hereinafter, an automated rail tie testing machine/system was assembled and tested. The machine consisted of the following components;

A portable frame on wheels to suit the railway gage to be tested,

A sensor to determine when the machine is positioned over each tie to be tested,

A “tapper” in the form of a rotating solenoid with a fixed ball acting as an impact or contact energy source

Microphone sensors,

Data acquisition software to acquire, archive, analyze and evaluate Surface/Rayleigh waves and velocity data,

A marking system to mark distressed ties as the machine rolls along the track.

Tie position/recording function to record the location of each tie tested.

The objective of the system is to evaluate railway ties in real time as the machine/system is moved along the rails. Distressed ties can be marked in the field and a data printout at the end of the day can be produced which lists the location of each defective tie, for example the distance from starting point that can be plotted on a map, and the impact velocity data and rating for each tie tested.

In addition to the advantages over visual inspection listed above, the machine provides a repeatable scientific measurement that can be related to the strength of the concrete and structural condition of each tie tested. Because the measurements are repeatable, comparison of data from subsequent measurements can be used to objectively document the deterioration rate of each rail tie and provide data to schedule and plan rail tie retesting or replacement.

The method thus uses microphone sensors and a “tapper” contact energy source to acquire impact velocity data at a rate of approximately 2 to 3 miles per hour. Data acquisition software acquires, archives, analyzes and evaluates Surface/Rayleigh wave Velocity data and marks distressed crossties as the system rolls along the track. The end products are distressed crossties marked in the field and a data printout at the end of the day listing the location (distance from starting point that can be plotted on a map), the impact velocity data and rating for each crosstie tested.

Testing and experimentation has determined that microphones placed at a distance from the surface are a suitable and a desirable alternative to previously used piezo ceramic contact sensors. However these can still be used. Comparison of data acquired with piezo ceramic crystals and the microphones determined similar Rayleigh wave velocity values. Several impact energy sources were evaluated and it was determined that a rotating solenoid with a ball fixed on a semi rigid wire acting as a tapper produced a Rayleigh Wave that was detectable with the microphone sensors the length of the crosstie. To automatically activate the data acquisition, a magnetic proximity switch triggers the system when it passes by the steel rail clips.

Computer software acquires, archives, processes and interprets Rayleigh wave data as it is acquired. Using Rayleigh wave velocity ranges, the software rates each crosstie on a 1 to 5 (1 no damage and 5 severely damaged) scale similar to rating systems used by AMTRAK and Union Pacific and automatically marks crosstie rated 4 and 5 with a paint mark.

The system is carried on a light weight on rail carriage which can be lifted from the rails by 2 men to allow trains to pass on active rail lines. This system can also be modified to be pushed or towed by a high rail vehicle.

Test results also have determined that the data can be acquired in an automated production mode at a rate of 1 crosstie every 1 to 2 seconds, which is approximately 1 mile per hour. Higher speeds of 2 or 3 mph can also be achieved. The results of this testing determined that Rayleigh wave velocity values are the best indicator of the internal condition of concrete “sleeper” ties.

Most of the crosstie is hidden from view by ballast and consequently serious defects that affect the integrity of the crosstie are not visible and can be missed. It is also difficult to quantify the severity of flaws based solely on a visual inspection and comparison of visual results from previous inspections is subjective. Crosstie deterioration can be rapid. In areas where a deteriorated cracked crosstie is observed in an inspection, there may be numerous consecutive fractured weakened crossties in the next inspection. This poses a safety risk and difficulty in planning crosstie replacement schedules. The testing method herein can detect internal flaws (not visible), provide wave velocity data (related to the strength of the crosstie) to document the current crosstie condition. Velocity data acquired by subsequent testing can be combined with usage (train speed and weight) data to help predict which crossties are weakening/deteriorating, how fast the deterioration is occurring and when replacement should be scheduled.

Concrete crossties are an essential component of the high speed rail system and key element in the safe operation of high speed rail. A reliable scientific assessment of the structural performance of each crosstie is essential to insure the safe operation of high speed rail. Concrete crossties were believed to be more economical than wood crossties because of a longer service life and consequently lower maintenance cost. This has not proven to be the case. Data indicating specific locations of weakening concrete crossties with an anticipated deterioration rate can provide data to plan repairs. Repair planning includes identifying weak crossties for replacement before adjacent “Good” crossties deteriorate, prolong the useful life of the crossties and extending the time between scheduled crosstie replacements or determine when a stretch of crossties should be scheduled for replacement. It is well documented that deteriorating concrete crossties is an issue for railroads and consequently a testing program that can identify internal flaws, scientifically document the structural integrity and assist in the repair scheduling strategies is important for high speed rail.

Crosstie dissection and crack mapping observations indicate the pattern of crack propagation does not include cracking visible in the top surface until the side and cross-section cracks have progressed to a moderate stage of deterioration. The top cracks are a later-in-time indication of onset cracking and stage of deterioration and unfortunately not an early indicator of the process. The crossties documented in this investigation demonstrate that by the time a crack is visible in the top chamfer and top surface to a length of several inches, the pattern of cracking along the sides of the crosstie and within the crosstie has progressed significantly. Comparison of visual distress with the actual extent of cracking present and the findings indicates that the in-service top surface visual inspection is less capable of identifying crossties in the early stages of cracking and deterioration compared to the non-destructive the measurements. Silt filled ballast and wet ballast do not affect results.

Crossties which are canted or inclined due to tamping and unevenly spaced crossties, as a result of crosstie replacement, are the primary hindrance to faster testing rates. Crossties on curves are only slightly cantered and did not pose a problem for production testing. Improvements to the sensor drive mechanism increase this production rate to 1 crosstie per second, 3600 crossties or 1.4 miles per hour. The use of non-contacting microphone sensors, proximity switches activated by rail clips, real time data analysis and mechanical design changes also improve production testing rates.

The test results are presented as a 1 to 5 crosstie rating/ranking system, similar to that currently used by railroad visual crosstie inspection, where 1 is “good”/like new crosstie and 5 is a highly distressed crosstie. A comparison of visual inspection results and non-destructive testing indicate similar ratings. The exception to this is the evaluation of crosstie center cracking. Crossties with center cracking display no significant drop in end to end wave velocity values measured. Close examination of these crossties determined the center cracking, although extensive only extends to the top of the pre-stressed portion of the crosstie. Cracking did not propagate into pre-stressed regions of the crosstie and therefor the crosstie still has a major portion of its cross section that is not cracked or weakened. If the cracking extends into and through the pre-stressed portion of the crosstie, the wave velocity measurements would be affected.

The technology provides a repeatable scientific measurement that can be related to the strength of the concrete and structural condition of each crosstie tested. Because the measurements are repeatable, comparison of data from subsequent measurements can document the deterioration rate of each crosstie and provide data to schedule and plan crosstie retesting or replacement.

Rayleigh waves produce sound as they propagate through concrete that can be detected by common microphones. Experiments indicate that the microphones can detect Rayleigh waves and that these sound waves have the same velocity as the particle motion wave measured by piezo-ceramic sensors used for crosstie measurement.

Alternate wave generation sources can be used and include: spring activated point source similar to a center punch used in machine shops, a metal ball on a metal arm to create a glancing impact and a projectile impact where the projectile is captured so it cannot fly and cause damage.

The software provides a real time analysis of the impact velocity data and within seconds provide a crosstie condition rating. Testing has indicated that the velocity that Rayleigh waves propagate from the end of the crosstie to inside the rail is the most diagnostic of the crosstie condition. Rayleigh waves are high amplitude and the only wave other than background noise on microphone data. A software program that uses the amplitude of waves can determine Rayleigh wave velocity values in real time. In other cases signal processing of the piezo ceramic sensor data can be used. This program acts to trigger a device to mark each crosstie with a rating or trigger a locating system to record the coordinates of suspect crossties.

The system can typically acquire data at a rate of approximately 2 crossties per second. Crossties that are misaligned (contoured) or are not spaced evenly contribute to slowing data acquisition. However where the rail clips are used to adjust or locate sensor positioning on the crossties, that is, if the rail clips are used to position the sensors on each crosstie, data quality and speed will increase. Even using the microphone sensors, this system is still important or desirable to position the microphones approximately over the center of the crosstie. Speed of up to 3 miles per hour is obtainable with a goal of 5 miles per hour.

Measurements made with a microphone positioned beside a piezo ceramic contact sensor using a projectile impact from an air pistol indicated that the microphones preferably used herein can detect the Rayleigh wave and at a similar velocity as the contact sensor.

Microphone sensors with a center frequency of approximately 20 kHz are best for detecting Rayleigh waves and more preferably a microphone with a center frequency of 17 kHz and with a sensitivity of −58 DBV/microbar and noise cancelling is preferred. Such microphones are commercially available and small and are readily available and inexpensive.

Microphones mounted in a shotgun configuration are preferred where the microphone is mounted in a tube so that the source of the sound detected by the microphone is from one direction. Preferably a ½ inch PVC tube with the microphone positioned approximately 3 inches inside the shotgun tube and approximately 2 inches above the surface of a concrete crosstie can be used.

A directional microphone housing also can be used to reduce noise and allow detection of Rayleigh wave signals when the microphone is not positioned directly over the crosstie. The results do not indicate an improvement in signal quality (less noise) but do allow for microphones to be off the edge of the crosstie but the signal is typically noisier.

If microphones sensors are used they can also be used as a trigger sensor for actuating a window of data acquisition when wave from the impact source is detected. A concern with using a microphone as a trigger is background noise; spurious background noises can trigger the data collection process. However noise does not appear to have any significant effect on the data recorded and a microphone can be used as a trigger for the data collection. The use of microphones shows that the crosstie thickness resonances (impact echo) are strong and the same frequency as the contact sensor.

Alternative energy sources can be used for defining the impact energy source which causes an impacting action on the surface of the concrete tie which generates the surface waves. This can include: a spring activated point source similar to a machine shop center punch; a metal ball on a stiff wire arm; and a bar drop impact.

As an alternative, the impact energy source can be a device which causes a rod impact that rebounds and is captured with a magnet, acting as a reusable impactor. A nail gun with a small finish nail can be used but produces a weak noisy signal. Using a tube as a guide and free falling rods can produce a good signal but the free falling rod is not as predictable in the impact time.

A set of impactors in the form of a ball carried on a stiff rod act to produce a sharp clean reproducible signal. Each impactor is a steel ball (⅛″ (3 mm) to ¾″ (19 mm) diameter on a stiff wire used to impact the concrete to generate energy for testing concrete. The small diameter (⅛″) impactors typically do not have enough energy to produce a good signal and are more difficult to work with. The large diameter balls produced a strong signal but also produced spurious frequencies. The middle sized impactors (⅜″ and 5/16″) provide the best results. The ball can typically have a mass of the order of 5 to 10 grams and is operated by the solenoid to travel at a speed of the order of 20 to 30 meters per second. This will produce an energy at the point of impact in the order of 4 joules. An energy level of greater than 3 joules is necessary to generate waves in the tie which can be detected by the system described herein. An energy level of up to 60 joules can be desirable which can be generated by a body of the same or similar weight moving at a much higher velocity of over 100 mps. Velocities of this order can be obtained by an untethered projectile fired by for example an air gun system or may be obtained by a tethered body such as a ball on an arm or wire where the actuating system is selected to generate sufficient velocity. A suitable selected rotational solenoid may meet these criteria.

A programmable controller is programed to activate the solenoid when a magnetic proximity switch passes by rail clips on each crosstie. The magnetic proximity switch, controller and rotational solenoid impactors are mounted on the vehicle or cart and the system can be used to impact on the crossties at speeds up to 3 mph.

A data acquisition program is provided that acquires, archives and displays the microphone data. This program obtains data from two separate sensor arrays spaced along the rails 1 foot apart so that one is actuated later than the other. The arrays are arranged in symmetrically opposite locations and acquire data at opposite ends of adjacent crossties. Each array is triggered by its own proximity switch activated when the system moves past the rail clips. The program includes the feature that if data is not acquired (missed) on two consecutive ends of a tie, an audible alarm is sounded with a visual display.

A second interpretation part of the software establishes a zero time, the instant the Rayleigh waves pass, or are sensed by, the microphone sensor closest to the tapper impact energy sources, and the time for the signal to propagate to the microphone inside the rail and the third sensor next to the opposite rail. Distances between sensors are known and so the measured times can be used to calculate the average Rayleigh wave velocity. The velocity values measured separately at each end of the crosstie are compared and the lowest velocity value is used in the decision tree below to rank or grade the crosstie.

A third part of the software acts to activate a paint spray mechanism schematically indicated at 28 to mark crossties rated grade 3, 4 or 5 (weak, fractured delaminated crossties).

The system thus acts to work with the impact energy sources and shotgun microphone sensors. The system is light weight-entire with the system less than 150 pounds. The system uses quiet-polyurethane wheels, no sensor contact; automatic triggering using the proximity switch and rail clips; and tapper impact energy source so that there are no flying projectiles. The system can be portable so that it folds up for transport. There are no compressed gas bottles. The system carries the components for automatic data analysis and marking of the severely deteriorated crossties when detected. The use of polyurethane wheels is very quiet and reduces noise for the microphones.

The microphone data acquired is interpreted to rate each crosstie from 1 to 5 using the decision tree described hereinafter. A visual inspection using AMTRAK's “Concrete Tie Condition Evaluation & Safety Inspection Procedure” provides results which compare with the microphone rating data. This comparison indicates a reasonable comparison of results, given the visual inspection can only see a limited area of the crossties.

### BRIEF DESCRIPTION OF THE DRAWINGS

One embodiment of the invention will now be described in conjunction with the accompanying drawings in which:

FIG. 1 is a top plan view of the components of the system according to the present invention operating on a rail track including a plurality of ties.

FIG. 2 is an end elevational view of the system of FIG. 1.

FIG. 3 is an end elevational view similar to that of FIG. 2 showing the components mounted on a schematically illustrated vehicle.

FIG. 4 is a top plan view similar to that of FIG. 1 showing the vehicle of FIG. 3.

FIG. 5 is an isometric view of the vehicle of FIG. 4.

FIG. 6 is a side elevational view of the components of the system of FIG. 1.

FIG. 7 is a schematic illustration of a modified microphone system for use with the system of FIG. 1.

FIG. 8 is a chart showing the selection of ratings of the concrete ties after testing depending upon the velocity of the waves that detected.

FIG. 9 is a graph showing the waveforms from two separate sensors where the waveform is stored in windows containing data from before and after the arrival of the leading edge from the impact.

In the drawings like characters of reference indicate corresponding parts in the different figures.

### DETAILED DESCRIPTION

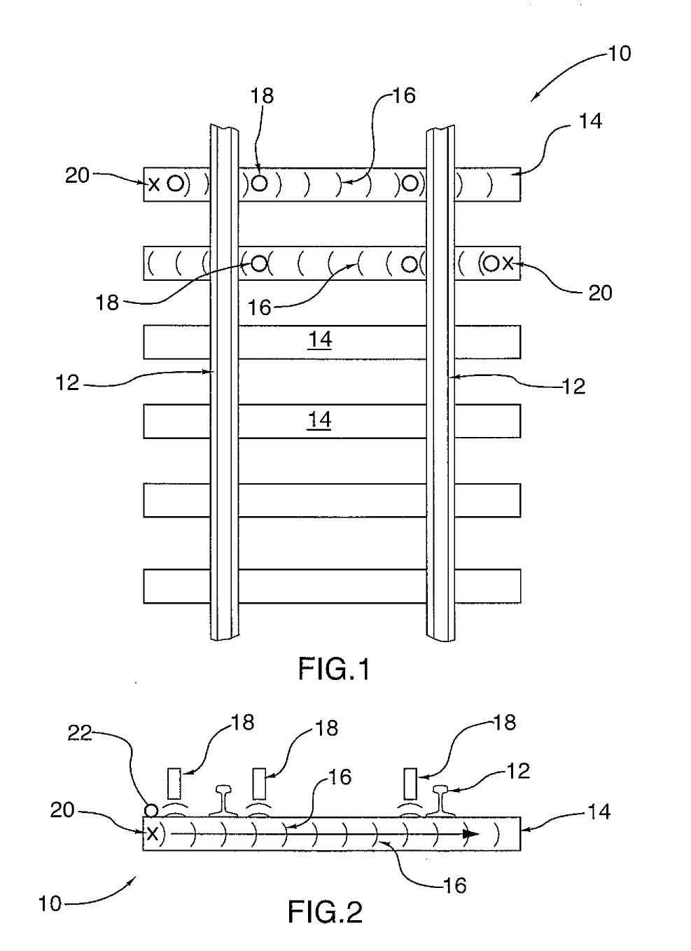

One example of a concrete testing system can be seen in the conceptual illustrations of FIGS. 1 (top view) and 2 (front view). In both figures a concrete testing system 10 may be moved upon railroad tracks 12 to evaluate the concrete railroad ties 14 to which they are secured. Waves which are typically Rayleigh but include compressional pressure waves 16 are propagated along and through the railroad tie 14. Sensing devices 18, such as microphones, detect the air pressure waves that emanate from the tie 14 due to movement of the surface of the ties due to the waves 16 within the structure.

The pressure waves 16 are generated at contact point 20 at one end of a concrete railroad tie 14 and propagate through the tie 14 from one end to the other. The sensing devices 18 are located along the length of the tie 14 to detect the pressure waves 16, allowing an assessment of the degree of cracking/concrete deterioration of the concrete tie 14.

FIG. 2 shows the location of the sensing devices 18 above a railroad tie 14 with the emitted pressure waves 16 being detected by the sensing devices 18.

FIG. 2 shows a front view of concrete testing system 10 with an energy impact source 22 at the point 20 and three sensing devices 18 above a railroad tie 14, with two rails 12 attached upon the railroad tie 14.

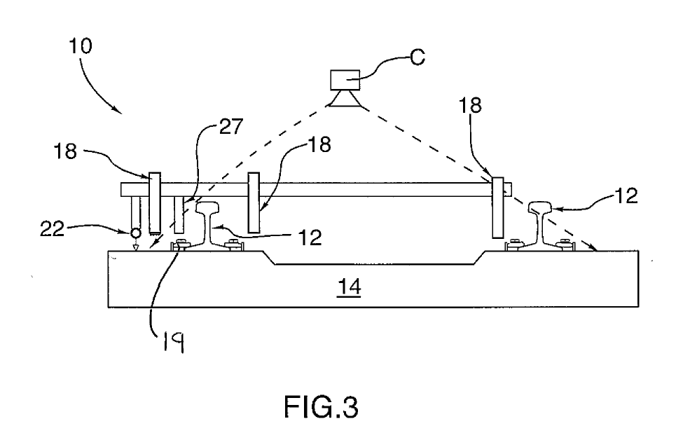

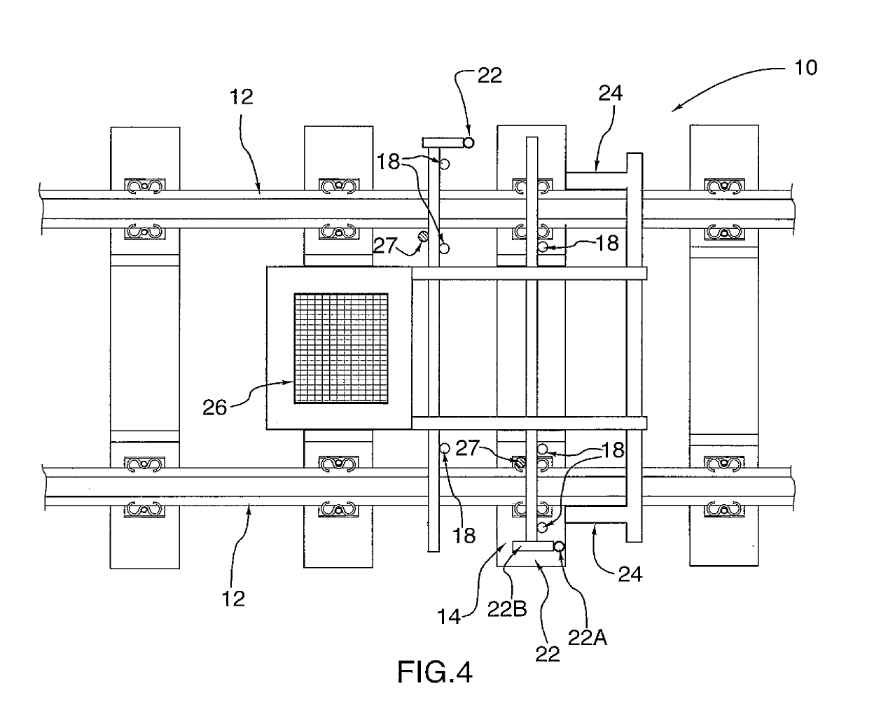

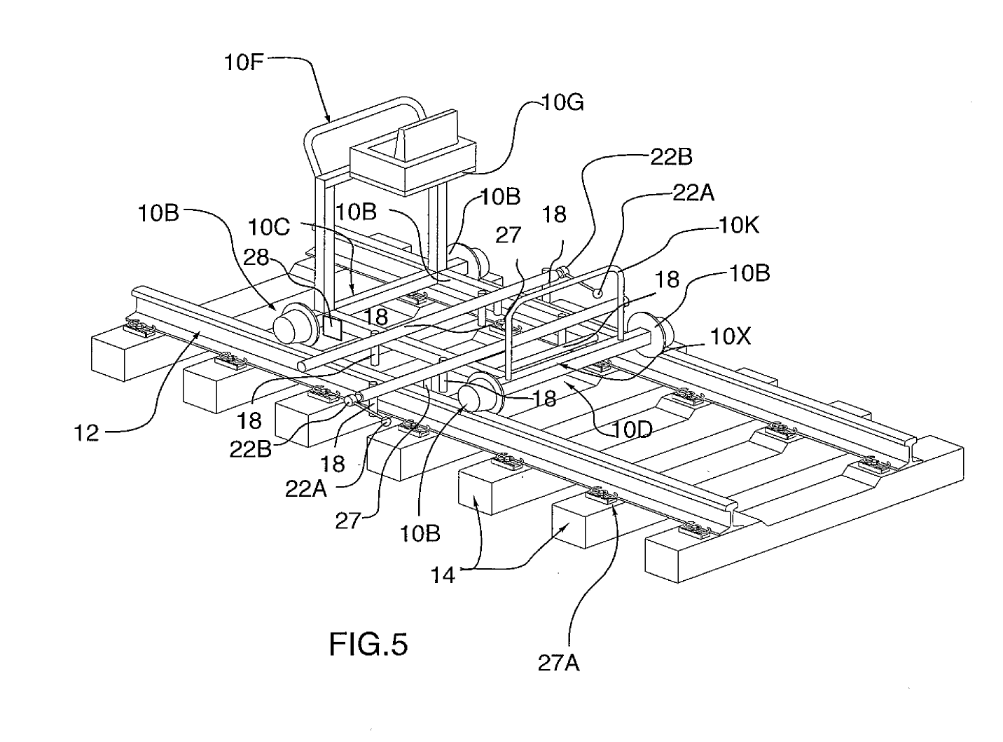

FIG. 3 shows a top view of a concrete testing system 10 as it is positioned upon railroad tracks 12 and the respective supporting railroad ties 14. This embodiment has two sets of impact energy sources 22 and sensing devices 18, each arranged above opposing ends of the railroad ties 14. These are located at 1 foot spacing along the rail so that one is between one tie and the next as the other is carrying out the testing procedure, with the ties 2 feet on center. This allows testing to be done on both ends of the ties 14 as the testing system 10 progresses along the rails 12 from one railroad tie 14 to the next. Proper positioning over the relevant railroad tie 14 to be tested is maintained by a proximity switch 27 activated by the metal tie clips 19 which fasten the railroad tracks 12 to the ties 14. The concrete testing system 10 moves along rails 12 and continues to move as the impact source 22 generates the Rayleigh waves detected by the sensing devices 18. A sweeper can be provided to clear debris from the top of the tie so the impact source 22 may provide an impact on a clean surface. In this embodiment impact energy source 22 is a metal ball manipulated by an electrical rotational solenoid 22B. The surface of the tie 14 is impacted by the metal ball 22 when proper positioning has been established by the proximity switch above an individual concrete railroad tie 14. A data processing system 26 may be used to analyze the data from the sensing devices 18 to determine the degree of deterioration of the subject tie 14. The sensing devices 18 are located with the first at or near the impact energy source 22 and others farther away along the tie 14. Three or more sensors may be used and they may be positioned approximately 1.5 inches above the tie being tested. The sensors may be positioned at different distances above a tie being tested as long as the distance is consistent from one tested tie to another. Testing is optimized by reducing the distance as much as possible. Sensors are located approximately 6 to 8 inches from the end of the tie, therefore allowing data to be collected along the body of the tie 14.

The machine 10 is carried on a frame 10A with parallel axles 10C and 10D carrying plastic wheels 10B for rolling on the rails such that it can be rolled along a railway and test the ties as the machine passed over them. The frame includes longitudinal connecting beams 10E and upstanding front and rear supports carrying manually engageable handle 10F and a front hitch 10K. A platform 10G carries a container for the processing system. The machine components can also be assembled on a powered rail vehicle or train such that ties could be tested as the train moves along the track.

The machine includes the magnetic proximity switch 27 which is suspended from the frame such that it is in close proximity to the steel rail clips 27A when the machine passes by a tie. The processor is programed to activate the rotating solenoid 22B when the magnetic proximity switch 27 detects one of the rail clips located on each rail tie as the vehicle rolls forward along the rails. The magnetic proximity switch 27, controller 26 and rotational solenoid impactors 22 are mounted on the frame. The frame further includes the toolbars 10X and 10Y extending parallel to the axle 10C and 10D. The toolbars carry the various components described herein at the required positions along the length of the tie 14 and at the required positions relative to the centreline 14A of the tie 14.

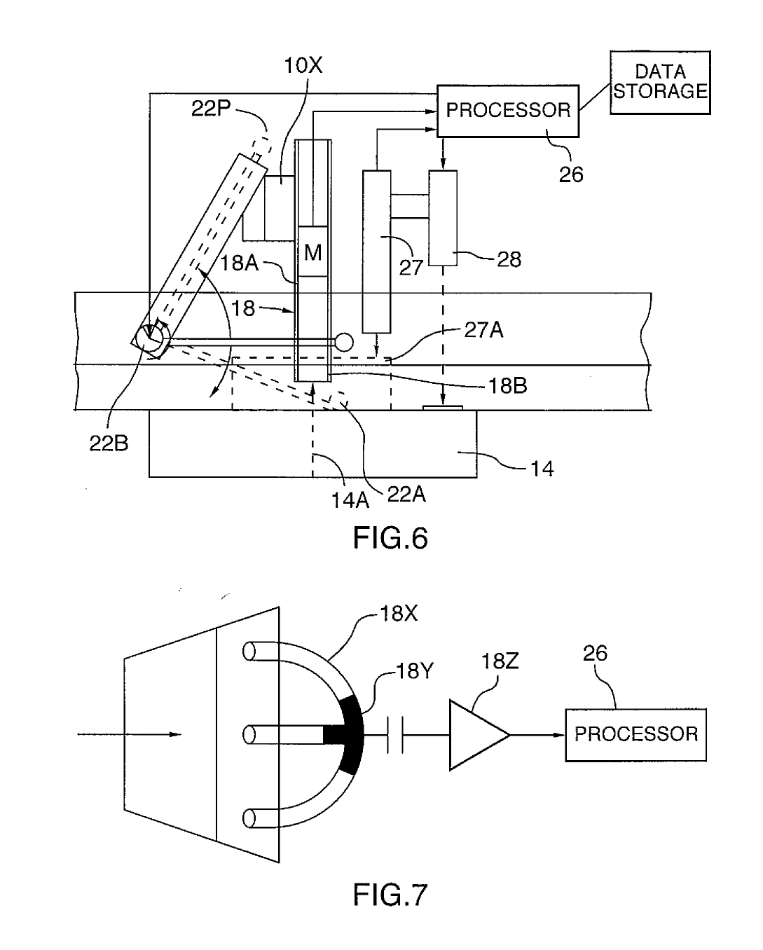

In this way the cart or vehicle moves continuously along the track carried on the plastic wheels so as to avoid excessive noise which could interfere with the microphones. As soon as the position sensor 27 detects the presence of the rail clip 27A, without halting the movement of the system, the processor 26 actuates the rotating solenoid 22B which moves the impact ball 22A from a raised storage position 22P to a position impacting the upper surface of the tie. The relative positions of the components are shown in FIG. 6 so that the detection of the clip occurs at a position where the ball 22A impacts the tie 14 approximately at the centre line 14A. The microphone sensors are mounted on the toolbar 10X of the frame and detect the arrival of Rayleigh waves. The sensors detect Rayleigh waves. The timing of the impact from the impact ball 22A on the tie does not need to be calculated relative to the sensors 18 since the sensors 18 themselves detect the wave generated by the impact. The sensor 18 which is closest to the impact therefore receives the wave first and acts as a method for detecting time zero which is fed to the processor 26. The time difference between the receipt of the wave at the first sensor and the receipt of the wave at the further sensors set at a predetermined distance from the first sensor provides an ability for the processor 26 to calculate the velocity of the wave as it travels along the tie. Depending upon the deterioration in the body of the tie, the velocity will change so that a number of different velocities maybe calculated by the processor using the detection of the waves by the sensors. The processor acts to detect from the complex waveform generated by the sensors the leading edge of the waveform which can be consistently detected as the leading edge passes each of the sensors. In this way there is no need to carefully coordinate the timing of the impact relative to the sensors.

The microphones are mounted in a shotgun configuration where the microphone M is mounted in a tube 18A so that the source of the sound detected by the microphone is from one direction longitudinal of the tube. A ½ inch PVC tube 18A with the microphone M positioned approximately 3 inches inside the shotgun tube from the mouth 18B and approximately 2 inches above the surface S of the concrete crosstie under test gives good results.

A directional microphone housing mounted within the tube to increase the directional effect can reduce noise and allow detection of Rayleigh wave signals when the microphone is not positioned directly over the crosstie. The results did not indicate an improvement in signal quality but did allow for the microphones to be off the edge of the crosstie but the signal was nosier.

In addition to using the microphone as a sensor, the microphone can be used as a trigger to initiate measurements to be made. A concern with using a microphone as a trigger is background noise; spurious background noises could trigger the data collection process. Background noise experiments conducted using a radio at high volume with static to simulate high frequency noise and drums to simulate low frequency noise. The background noise did not appear to have any significant effect on the data recorded and a microphone thus can be used as a trigger.

Alternative energy sources including a pneumatic projectile energy source, spring activated point source similar to a machine shop center punch; metal ball on a stiff wire arm; electric solenoid; pneumatic solenoid; and a bar drop impact were considered. All energy sources use microphones in the optimal tube configuration described above. The machine shop center punch produces a reasonably good Rayleigh wave signal.

Electric and pneumatic vertical solenoids can produce a lower frequency signal but were not practical to take measurements while moving as it is necessary to immediately retract the impact body so as to rebound or retract to prevent drag along the rail tie surface creating a noisy signal which will provide difficulty reading Rayleigh wave arrivals.

The processor 26 includes software arranged to acquire, archived on the display the microphone data from two separate sensor arrays with sensors spaced 1 foot apart to be able to acquire data at opposite ends of each rail ties. Each array is triggered by its own proximity switch activated when the machine moves past the rail clips. The program includes that if data is not able to be acquired or is missed on the ends of two consecutive ties an audible alarm is sounded with a visual recording on the display.

The impact energy source shown in FIG. 6 includes at the solenoid 22B a spring schematically shown at 22C which acts so that the body 22A is immediately retracted after impact so as to prevent sliding movement across the surface. The spring is typically a part of the solenoid itself so that it is not a separate component there is provided either as an integral or separate component an arrangement for immediate retraction of the ball of body after it impacts the surface.

The processor 26 includes a program component causing analysis which includes detecting the speed of the waves at different locations across the tie and comparing the different speeds to determine a uniformity of the speed.

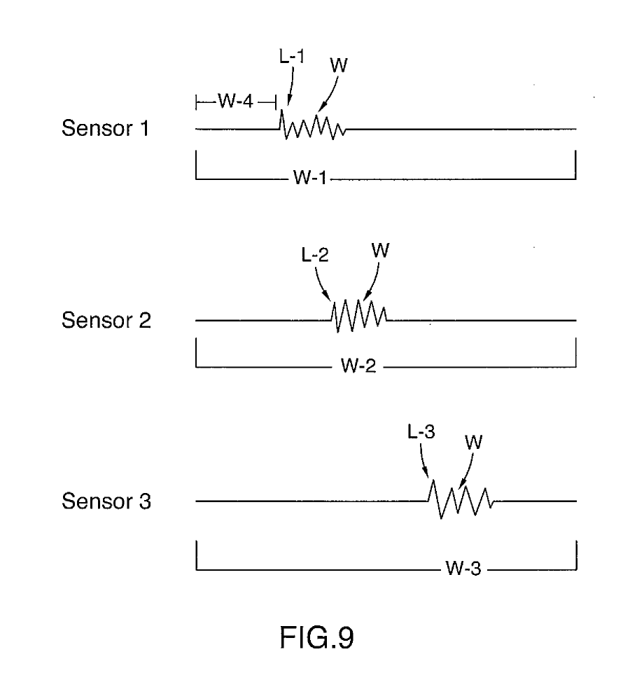

As shown in FIG. 9, the analysis includes detecting the waves at different locations as indicated at SENSOR 1, SENSOR 2, 3 across the tie. Each sensor generates and stores in the program SENSOR 26 for each impact a waveform W for each sensor over a period of time or window W1, W2 and W3 of the impact at the location. The program in the processor acts to compare the time of arrival for each waveforms W in the windows W1, W2 and W3 from different locations. The waveforms in the windows W1, W2 can also be compared from different ties. As shown the impact generates a waveform W with a leading edge L1, L2 or L3 recorded at each sensor location caused by the impact with a waveform of decreasing amplitude behind the leading edge. When L1 is detected, the recording time for sensors 1, 2, and 3 is advanced by W4 of the continual waveform W and extracted from the continual waveform. W1, W2 and W3 are recorded for a designated time period. Thus the continual waveform W1, W2 and W3 are stored in a buffer and the window extracted from that buffer when triggered by the detection of the leading edge L.

The analysis is repeated by travelling the vehicle along the same track over the same ties after a period of time which can be several months or even years and results from the separate analyses compared to determine a rate of deterioration.

As shown in FIG. 3 there is provided a camera C carried on the vehicle for generating a visual image of the tie under test which is recorded with data from the analyses so that the review of the condition state of a series of tests along the rail track can be carried out using both the velocity data stored and the visual image stored.

FIG. 7 shows a more complex microphone system provided for the sensors 18. In this arrangement a complex waveguide tube 18X is provided which includes three separate legs connecting to a central collector portion 18Y for communication to an amplifier 18Z. In this way the specific location of the sensor 18 to the surface of the tie is less sensitive since one or other of the legs can be located beyond the edge of the tie.

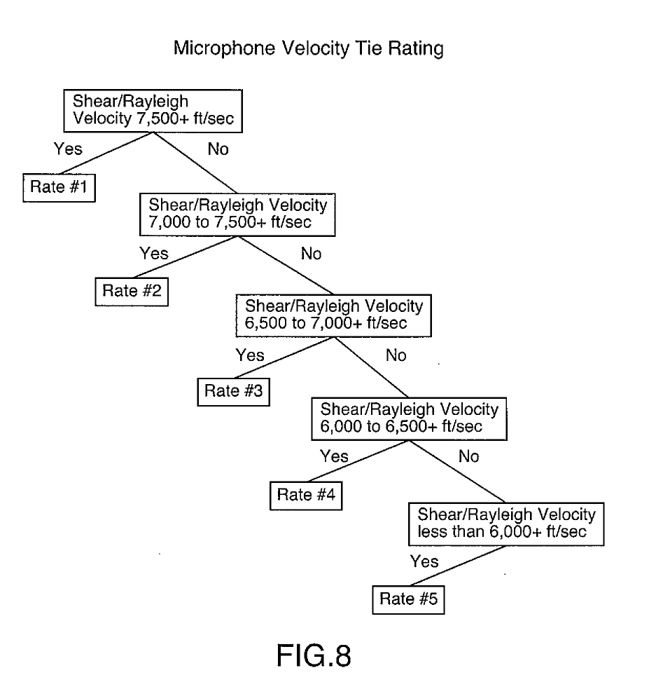

In FIG. 8 is shown a flow chart providing the analysis of the velocities of the waves in the tie which are detected by the senses relative to the conventional rating system providing an indication of rating of 1 to 5.

Benefits of the system include:

Automation of rail tie evaluation to use steel tie clips to locate and trigger sensors and energy source near the middle of each tie.

Use of non-contacting microphone sensors as well as contact sensors if desired.

Use a range of energy sources (mechanical, impact and non-contacting).

Data acquisition software that can sense when a reading should be made and instantaneously evaluate and rate/rank and log data for each tie tested.

Automatically mark ties according to the rating/ranking measured.

Equipment can be mounted on a portable rail mounted cart or can be attached to a high rail vehicle or train.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of testing railroad ties comprising:
providing an impact energy source that impacts the tie so as to create waves that propagate through the tie;
providing one or more sensing devices arranged to sit above the surface of the tie so as to avoid contact therewith, where the sensing devices detect movement of the surface caused by the waves propagating therein; and
analyzing and/or recording the detected pressure waves to determine properties of the tie.

2. The method according to claim 1 wherein including moving a vehicle continually along rails mounted on the ties, detecting presence of one of the ties under the vehicle, at positions spaced longitudinally from the impact energy source providing a plurality of sensing devices to detect said at least one wave and detecting a time of arrival of said waves and analyzing the time of arrival from said sensing devices to determine a speed of said waves in the tie.

3. The method according to claim 2 including, in the event that the speed in said tie is below a predetermined speed, providing an output indication of a deterioration of the tie.

4. The method according to claim 1 wherein the impact energy source comprises a body carried on a support which provides an impact on the surface of the tie and is immediately retracted so as to prevent sliding movement across the surface.

5. The method according to claim 1 wherein the impact energy source is shaped, arranged and actuated to provide a frequency of waves in the tie which includes frequencies below 25 kHz and preferably below 10 kHz and more preferably below 5 kHz.

6. The method according to claim 1 wherein the impact energy source is shaped, arranged and actuated to provide an energy at impact of greater than 3 Joules.

7. The method according to claim 1 wherein the analysis includes detecting the speed of the waves at different locations across the tie and comparing the different speeds to determine a uniformity of the speed.

8. The method according to claim 1 wherein the analysis includes detecting the waves at different locations across the tie and generating for each impact a waveform over a period of time of the impact at the location and comparing the waveforms from different locations and/or from different ties.

9. The method according to claim 1 wherein the period of time includes times in advance of the impact obtained by recording a continual waveform and obtaining from the continual waveform recorded a window of time in advance of and after the impact.

10. The method according to claim 1 wherein the sensors detect waves at the surface which are changed by wave components that are reflected and diffracted between surfaces of the structure and are indicative of delamination of or cracks in the structure below the surface.

11. The method according to claim 1 wherein the impact energy source is provided by a ball carried on a tether and operated by a rotational drive device so as to engage a surface of the tie.

12. The method according to claim 1 wherein the presence of one of the ties is detected by a proximity sensor, a magnetic sensor, a contact sensor, or a video sensor for actuating the impact energy source.

13. The method according to claim 1 wherein the sensing devices are spaced away from a surface and detect air movement generated by the surface wave in the tie.

14. The method according to claim 13 wherein sensors comprise a microphone positioned inside a tube, an open end of which is directed toward the surface of the tie.

15. The method according to claim 1 wherein the non-contact sensor is a laser sensor for detecting movement of the surface.

16. The method according to claim 1 wherein an output indication of a deterioration of the tie is used to place the ties in categories of a degree of deterioration.

17. The method according to claim 16 wherein velocity ranges for deteriorated ties are determined and then used to classify the tie tested in the categories of deterioration.

18. The method according to claim 1 wherein including a marking system for marking the tie under test in the event that it is determined to be deteriorated.

19. The method according to claim 1 wherein there is provided a position recording function to record a position of each defective tie along the rails and the data is analyzed in a post-survey analysis of the data to produce a summary report of the number and location of defective ties.

20. The method according to claim 19 wherein data from a subsequent survey is compared to previously recorded data for each tie to determine deterioration vs time and rate of deterioration of ties.

21. The method according to claim 1 wherein the rail clips are used to position the sensors on each tie.

22. The method according to claim 1 wherein the analysis establishes a zero time when the wave from the impact first passes a first senor closest to the impact energy source, and the time for the signal to propagate to a second and third sensor is used to calculate wave velocity.

23. The method according to claim 1 wherein there is provided a vehicle with wheels for rolling on the rails where the wheels are formed of a resilient polymer, plastics or rubber material.

24. The method according to claim 1 wherein the analysis is repeated after a period of time and results from the separate analyses compared to determine a rate of deterioration.

25. The method according to claim 1 wherein there is provided a camera for generating a visual image of the tie under test which is recorded with data from the analyses.

26. The method according to claim 1 wherein there is provided a first impact energy source at a first end of the tie and a first array of sensors along the tie for a first analysis and a second impact energy source at a second end of the tie and a second array of sensors along the tie for carrying out a second analysis.

27. The method according to claim 26 wherein the first array comprises a first sensor between the first impact source at the first end of the tie and a first rail, a second sensor on the other side of the first rail and a third sensor adjacent the second rail and the second array comprises a first sensor between the second impact source at the second end of the tie and the second rail, a second sensor on the other side of the second rail and a third sensor adjacent the first rail.

28. The method according to claim 1 wherein each array includes a respective sensor for detecting the tie.
